(19) United States
(12) Patent Application Publication
(10) Pub. No.: US 2008/0011117 A1
(43) Pub. Date: Jan. 17, 2008

(54) XY PLANAR SYSTEM WITH A VERTICALLY DECOUPLED X AXIS AND Y AXIS

(75) Inventors: Clement William Hennessey, Golden, CO (US); Daniel Fording Crews, Evergreen, CO (US); Nathan Lyons Brown, Littleton, CO (US)

Correspondence Address: SETTER ROCHE LLP, P.O. BOX 780, ERIE, CO, 80516, US

(73) Assignee: ALIO Industries, Inc., Wheat Ridge, CO (US)

(21) Appl. No.: 11/769,117

(22) Filed: Jun. 27, 2007

Related U.S. Application Data
(60) Provisional application No. 60/817,305, filed on Jun. 28, 2006.

(51) Int. Cl. G05G 11/00; F16C 17/26

(52) U.S. Cl. 74/490.08; 384/9

(57) ABSTRACT

An XY planar system having a base is disclosed. The base has a surface defining an XY plane, the XY plane has an X axis and a Y axis. An X guide coupled to the base. A first set of three main bearings riding on the surface and configured to constrain a Y stage in a Z direction perpendicular to the XY plane and to rotationally constrain the Y stage in an α and β directions where α is rotation about the X axis and β is rotation about the Y axis. The Y stage is coupled to the X guide and the X guide linearly constrains the motion of the Y stage along the Y axis and constrains the angular motion of the Y stage in the γ direction, where γ is rotation about the Z axis. The Y stage is configured to travel along the X guide in the X direction. A second set of three main bearings are coupled to the XY plane and configured to linearly support a carriage in the Z direction and to rotationally constrain the carriage in the α and β directions. The carriage is coupled to the Y stage and the Y stage linearly constrains the motion of the carriage along the X axis and constrains the angular motion of the carriage in the γ direction. The carriage is configured to travel along the Y stage in the Y direction.

### RELATED APPLICATIONS

This application claims the benefit of US provisional application No. 60/817,305 filed on Jun. 28, 2006 entitled “XY Planar system with a vertically decoupled X axis and Y axis,” which is hereby incorporated by reference into this application.

### BACKGROUND

FIG. 1 is a block diagram of an XY stage system 100. XY stage system 100 comprises an X-stage 102, a Y-stage 106, and a carriage 104. XY stage system 100 positions carriage 104 in the XY plane. Carriage 104 typically holds an object. XY stage system 100 can move carriage 104 in two dimensions along an X axis and a Y axis. The XY stage system has X-stage 102 and Y-stage 106 that provide support for movement along the X axis and the Y axis. Y-stage 106 is stacked on top of, and supported by, X-stage 102. Y-stage 106 rides along on top of X stage 102 as X stage 102 move back and fourth along the X axis. Support for movement along the X axis is coupled to the base of the XY stage system. Because the Y stage is stacked on top of the X stage, the bearings that provide vertical support for movement along the Y axis are not coupled directly to the base of the XY stage system. This stacking of bearings makes positioning errors additive, which makes the XY stage system less precise.

### BRIEF DESCRIPTION OF THE DRAWINGS

FIG. 1 is a block diagram of an XY planer system 100.

FIG. 2 is a block diagram of XY planer system 200 in an example embodiment of the invention.

FIG. 3 is an isometric view of XY planer system 300 in an example embodiment of the invention.

FIG. 4 is an isometric bottom view of Y stage 306 in an example embodiment of the invention.

FIG. 5 is a side view of Y stage 306 in an example embodiment of the invention.

FIG. 6 is an isometric top view of carriage 304 in an example embodiment of the invention.

FIG. 7 is a bottom view of carriage 304 in an example embodiment of the invention.

FIG. 8 is a block diagram of the bearing layout in an XY planar system in an example embodiment of the invention.

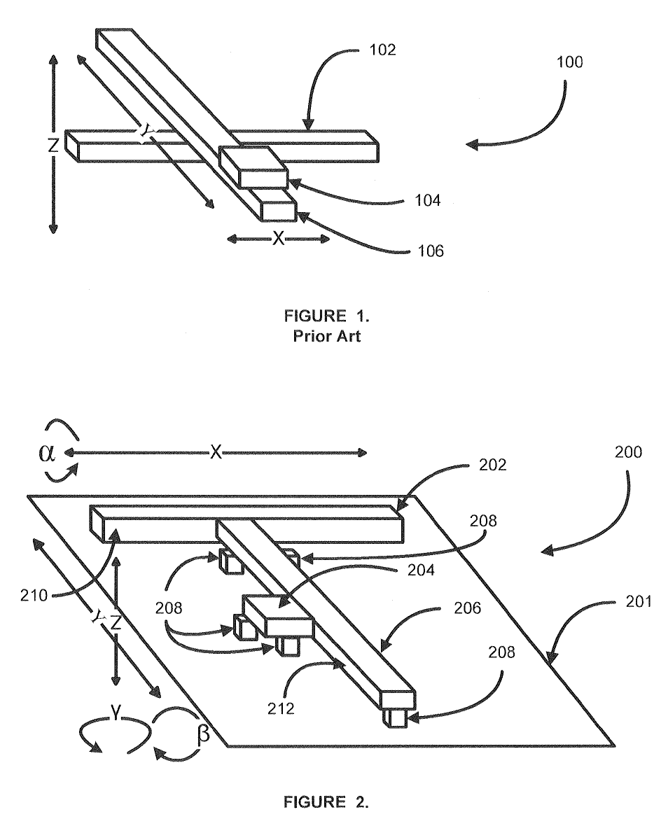

### DETAILED DESCRIPTION

An improved XY planar system positions a carriage that may hold an object. The improved XY planar system can move the carriage in two dimensions along an X axis and a Y axis. The improved XY planar system has bearings that vertically support movement along each of the X and Y axis. The bearings that vertically support movement along each of the X and Y axis are not stacked. This means that the bearings that provide vertical support for movement along the X axis are coupled to the base of the XY planar system and the bearings that provide vertical support for movement along the Y axis are also coupled to the base of the XY planar system. The coupling of both sets of bearings to the base removes the additive error and makes the XY planar system more precise. More precise is defined as improved flatness and straightness of travel as well as reducing pitch, and roll of the carriage during movement.

FIG. 2 is a block diagram of XY planer system 200 in an example embodiment of the invention. XY planer system 200 comprises a base 201, an X stage 202, a Y stage 206, a carriage 204, and a plurality of bearings 208. The top of base 201 defines a flat surface in the XY plane. In one example embodiment of the invention, base 201 may be a granite slab. The surface of granite slabs can be fabricated into very flat planes. A typical base flatness specification has a tolerance of 2 micro-meters (um) or less over the entire surface. Granite slabs are also typically insensitive to temperature changes. X stage 202 is attached to base 201. In one example embodiment of the invention, X stage may be a granite bar. Y stage 206 is supported in the Z axis by three bearings 208 that reference base 201. Carriage 204 is also supported in the Z axis by three bearings 208 that reference base 201. In one example embodiment of the invention, bearings 208 are air bearings that ride on the top of base 201. In other example embodiment of the invention, bearings 208 may be magnetic bearings or any other type of high precision bearings.

The three bearings that support Y stage 206 and the three bearings that support carriage 204 each define a plane that references the XY plane defined by the top surface of base 201. The two sets of three bearings constrain linear movement of the Y stage 206 and the carriage 204 in the Z axis. The two sets of three bearings also constrain rotational movement of the Y stage 206 and the carriage 204 in the a and P directions where a is rotation about the X axis and P is rotation about the Y axis. Rotation in the a and P directions may also be called pitch and roll.

The Y stage 206 moves in the X direction. The Y stage 206 is coupled to and references the X stage 202 to constrain the Y stage 206 in the Y axis and to constrain the rotational motion of the Y stage 206 in the γ direction, where γ is rotation about the Z axis. The carriage 204 is coupled to the Y stage and move in the X axis along with the Y stage. The carriage 204 also moves in the Y direction and is coupled to and references the Y stage 206 to constrain the carriage 204 in the X axis and to constrain the rotational motion of the carriage 204 in the γ direction. Because both Y stage 206 and carriage 204 reference the top surface of base 201 for linear displacement in the Z axis and rotational displacement in the α and β directions, errors in these axis are not additive.

Y stage 206 is coupled to and references X stage 202. In one example embodiment of the invention, X stage has a flat face (210) or straight side. Y stage references the flat face or straight side of X stage 202 to constrain the motion of the Y stage in the Y direction and in the γ direction. Carriage 204 is coupled to and references Y stage 206. In one example embodiment of the invention, Y stage has a flat face (212) or straight side. The flat face (212) or straight side of Y stage 206 is adjusted to be orthogonal with the flat face (210) or straight side of X stage 202. Carriage 204 references the flat face or straight side of Y stage 206 to constrain the motion of carriage 204 in the X direction and in the y direction.

Because Y stage 206 references the XY plane on top of base 201, deflections in X stage 202 in the Z axis or the a and P directions do not cause positional errors in these directions in the Y stage 206. This makes Y stage 206 insensitive to beam droop or beam sag in X stage 202, and insensitive to pitch and roll of X stage 202. This insensitivity allows the length of X stage to be increased without an accuracy penalty in these axes. Because carriage 204 references the XY plane on top of base 201, deflections in Y stage 206 in the Z axis or the α and β directions do not cause positional errors in these directions in the carriage 204. This makes carriage 204 insensitive to beam droop or beam sag in Y stage 206, and insensitive to pitch and roll of Y stage. This insensitivity allows the length of Y stage 206 to be increased without an accuracy penalty in these axes. The insensitivity of the XY planar system to the X and Y stages allow almost unlimited travel (meters in length) in the X and Y directions while maintaining positional accuracy. The travel distance in the X and Y directions is only limited by the size of base 201.

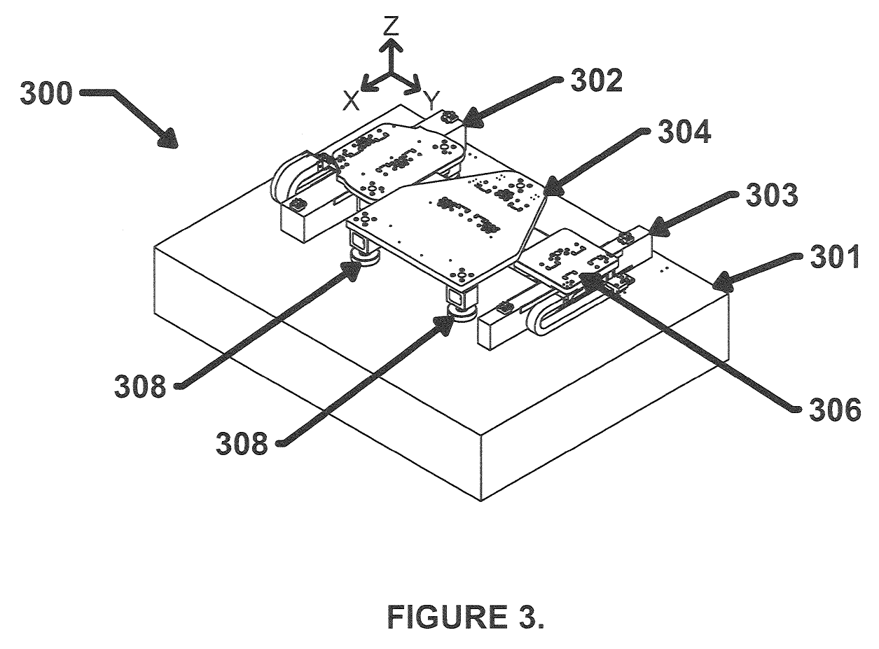

FIG. 3 is an isometric view of XY planer system 300 in an example embodiment of the invention. XY planer system 300 comprises base 301, X reference guide 302, auxiliary reference guide 303, Y stage 306, carriage 304, and a plurality of air bearings 308. Base 301 forms a flat surface in the XY plane configured to support the plurality of air bearings 308. X reference guide 302 is attached to the top surface of base 301. In one example embodiment of the invention, X reference guide is a rectangular bar attached to base 301. Auxiliary reference guide 303 is attached to the top surface of base 301, parallel to, and spaced apart from, X reference guide 302. Y stage 306 is supported by a first set (not shown in this view) of three air bearings 308 and slides along the X reference guide 302 in the X direction on top of base 301 in the XY plane. Y stage 306 is coupled to X reference guide 302 and constrained in the Y direction by X reference guide 302. Carriage 304 is supported by a second set of three of air bearings 308 (two bearings are visible in this view) and slides in the XY plane on top of base 301. Carriage 304 is coupled to Y stage 306 and moves with Y stage 306 as Y stage 306 moves in the X direction along the top surface of base 301 in the XY plane. Carriage 304 also moves perpendicular to X reference guide 302 by sliding along Y stage 306.

The three bearings that support Y stage 306 and the three bearings that support carriage 304 each define a plane that references the XY plane defined by the top surface of base 301. The two sets of three bearings constrain linear movement of the Y stage 306 and the carriage 304 in the Z axis. The two sets of three bearings also constrain rotational movement of the Y stage 306 and the carriage 304 in the α and β directions where a is rotation about the X axis and β is rotation about the Y axis. Rotation in the α and β directions may also be called pitch and roll. The Y stage 306 is coupled to and references the X reference guide 302 to constrain the Y stage 306 in the Y axis and to constrain the rotational motion of the Y stage 306 in the y direction, where γ is rotation about the Z axis. The carriage 304 is coupled to the Y stage and move in the X axis along with the Y stage. The carriage 304 also moves in the Y direction and is coupled to and references the Y stage 206 to constrain the carriage 304 in the X axis and to constrain the rotational motion of the carriage 304 in the y direction. Because both Y stage 306 and carriage 304 reference the top surface of base 301 for linear displacement in the Z axis and rotational displacement in the α and β directions, errors in these axes are not additive.

In one example embodiment of the invention, auxiliary reference guide 303 may be used to support the measurement system for measuring the motion in the X axis. The measurement system may be any system that can measure displacement at the accuracy required by the XY planer system 300, for example a linear encoder system, a laser interferometer, or the like. In another example embodiment of the invention, the X axis measurement system may be attached to X reference guide, and auxiliary reference guide 303 may not be present.

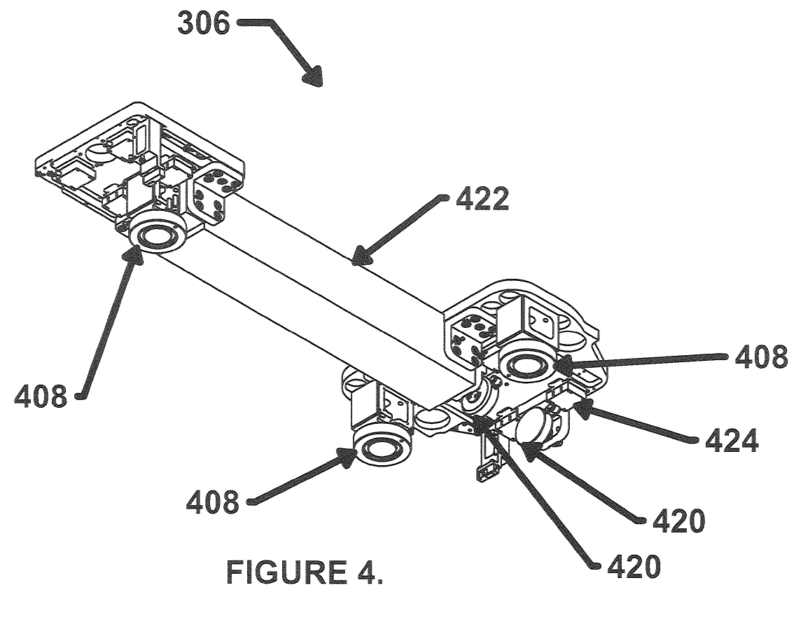

FIG. 4 is an isometric bottom view of Y stage 306 in an example embodiment of the invention. Y stage 306 comprises three main air bearings 408, cross beam 422, secondary air bearings 420, and motors 424. The three main bearings 408 support Y stage 306 on top of base 301. Two of the main bearings 408 are placed at one end of cross beam 422 in a spaced apart relationship. The third main bearing 408 is placed at the other end of cross beam 422, creating a three point support for Y stage 306. In one example embodiment of the invention, main air bearings 408 are vacuum preloaded air bearings that constrain the Y stage to a predetermined fly height above the top of base 301.

Secondary bearings 420 are configured to act on opposite sides of X reference guide 302. Secondary bearings 420 are configured to constrain Y stage 306 in the Y direction while allowing Y stage to travel along X reference guide 302 in the X direction. In one example embodiment of the invention, the two secondary bearings are placed opposite each other, one on each side of X reference guide 302. In another example embodiment of the invention, the two secondary bearings may be positioned, in a spaced apart relationship, on the same side of X reference guide 302, with a spring force acting between the two bearings on the opposite side of X reference guide 302. In one example embodiment of the invention, secondary bearings are air bearings. Air bearings only constrain motion in one linear direction, and do not constrain motion in the other two linear directions. Other types of bearings that constrain motion in one linear direction may be used, for example magnetic bearings.

Motors 424 act against X reference guide 302 and move Y stage 306 in the X direction. In one example embodiment of the invention, motors 424 may be ceramic servo motors. In other example embodiments of the invention, motors 424 may be linear magnetic motors.

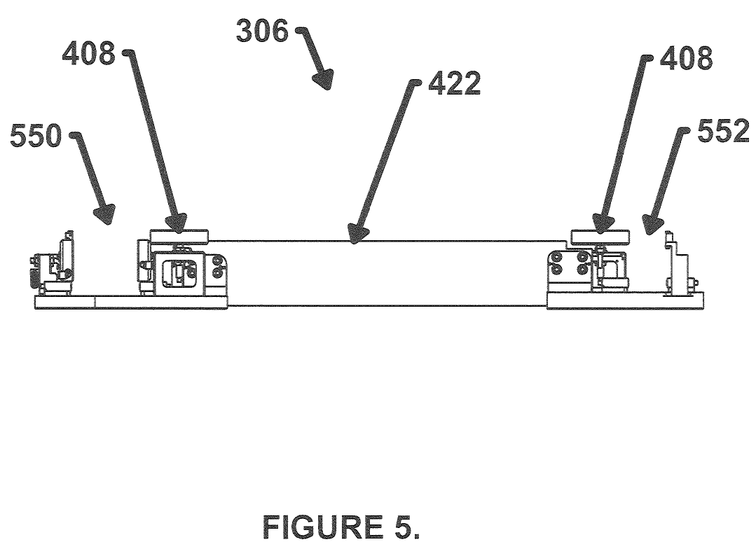

FIG. 5 is a side view of Y stage 306 in an example embodiment of the invention. Y stage 306 comprises main bearings 408 and cross beam 422. Y stage 306 fits over X reference guide 302 with X reference guide 302 inside slot or gap 550. Y stage 306 also fits over auxiliary reference guide 303 with auxiliary reference guide 303 inside slot or gap 552. The height of the two reference guides (302 and 303) is smaller than the height of the two gaps (550 and 552), allowing Y stage 306 to be supported in the Z axis by main bearings 408.

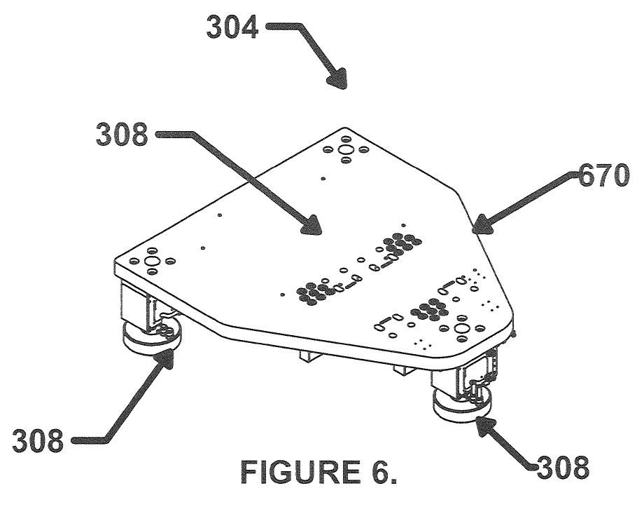

FIG. 6 is an isometric top view of carriage 304 in an example embodiment of the invention. Carriage 304 comprises main platform 670 and three main bearings 308. The three main bearings 308 support carriage 304 on top of base 301. The three main bearings 308 are spaced in a triangle around main platform 670 creating a three point support system. In one example embodiment of the invention, main bearings 308 are vacuum preloaded air bearings that constrain the carriage 304 to a predetermined fly height above the top of base 301.

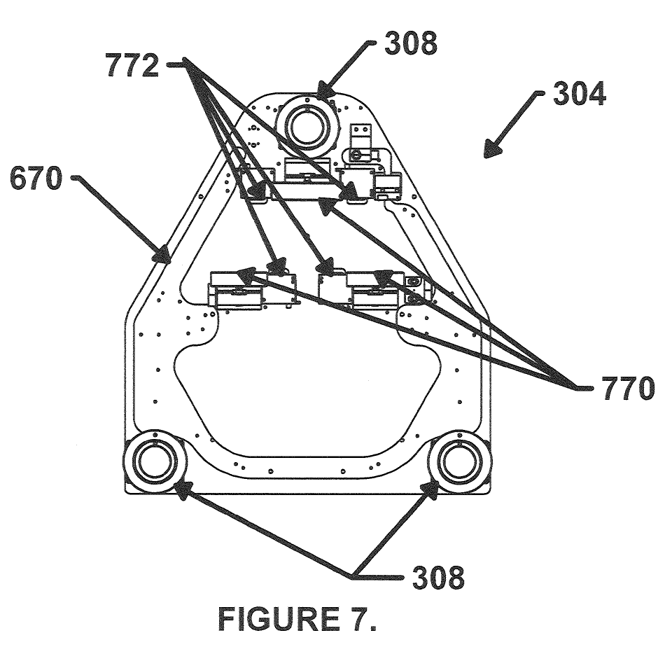

FIG. 7 is a bottom view of carriage 304 in an example embodiment of the invention. Carriage 304 comprises main platform 670, three secondary bearings 770, motors 772, and three main bearings 308. The three secondary bearings 770 are placed on either side of slot or opening 774, two on one side and one on the other side. Carriage 304 sits on top of cross beam 422 in Y stage 306. The three secondary bearings 770 are configured to fit on either side of, and reference, cross beam 422. Secondary bearings 770 are configured to constrain carriage 304 in the X direction while allowing carriage 304 to travel along cross beam 422 in the Y direction. Motors 772 mover carriage 304 along the length of cross beam 422 in the Y direction. In one example embodiment of the invention, motors 424 may be ceramic servo motors. In other example embodiments of the invention, Motors 424 may be linear magnetic motors.

In one example embodiment of the invention, a measurement system is coupled to carriage 304 and measures the relative displacement between carriage 304 and Y stage 306. The measurement system may be any system that can measure displacement at the accuracy required by the XY planer system 300, for example a linear encoder system, a laser interferometer, or the like.

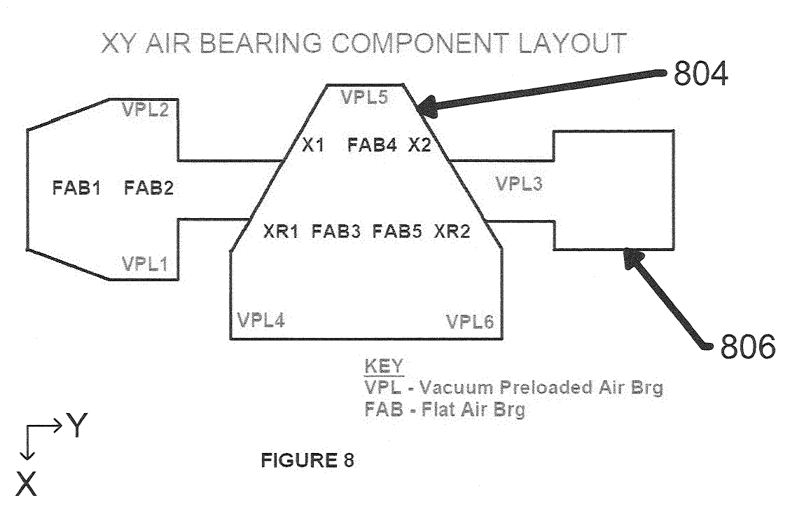

FIG. 8 is a block diagram of the bearing layout in an XY planar system in an example embodiment of the invention. FIG. 8 comprises Y stage 806 and carriage 804. Y stage 806 has three main bearings (VPL1, VPL2, and VPL3) that support the Y stage 806 in a direction perpendicular to the surface of the figure. Y stage also has two secondary bearings (FAB1 and FAB2) that are configured to constrain the motion of Y stage 806 in the Y direction. Carriage 804 has three main bearings (VPL4, VPL5, and VPL6) that support carriage 804 in a direction perpendicular to the surface of the figure. Carriage 804 also has three secondary bearings (FAB3, FAB4, and FAB5) that are configured to constrain the motion of carriage 804 in the X direction.

We claim:

1. A method of operating an XY planar system comprising:
providing a base having a surface defining an XY plane wherein the XY plane has an X axis and a Y axis;
supporting a Y stage on the surface in a Z axis with a first set of main bearings attached to the Y stage, wherein the Z axis is perpendicular to the XY plane, the Y stage being configured to translate in the X axis on the XY plane;
constraining the Y stage in the Y direction with a first set of secondary bearings that couple to an X reference guide wherein the first set of secondary bearings also constrains the Y stage in an γ direction wherein the y direction is a rotation about the Z axis;
supporting a carriage on the surface in the Z axis with a second set of main bearings attached to the carriage, the carriage coupled to the Y stage with a second set of secondary bearings and configured to translate with respect to the Y stage in the Y axis of the XY plane wherein the second set of secondary bearings constrains the carriage in the X direction and the γ direction.

2. The method of operating an XY planar system of claim 1, wherein there are three main bearings in the first set of main bearings and there are three bearings in the second set of main bearings.

3. The method of operating an XY planar system of claim 1, wherein the first set of main bearings and the second set of main bearings comprise vacuum preloaded air bearings and the base is fabricated from a granite slab.

4. The method of operating an XY planar system of claim 1, further comprising:
moving the Y stage in the X direction with a first set of motors that act against the X reference guide;
moving the carriage in the Y direction with a second set of motors that act against the Y stage.

5. The method of operating an XY planar system of claim 4, wherein the first set of motors and the second set of motors comprise ceramic servo motors.

6. The method of operating an XY planar system of claim 4, wherein the first set of motors and the second set of motors comprise linear servo motors.

7. The method of operating an XY planar system of claim 1, further comprising:
measuring the relative motion of the Y stage with respect to the X reference guide;
measuring the relative motion of the carriage with respect to the Y stage.

8. The method of operating an XY planar system of claim 1, wherein the carriage moves in the XY plane across a full range of motion with a rotation in an α and β directions of less than one arc-second, where α is rotation about the X axis and β is rotation about the Y axis.

9. An XY planar system comprising:
a base having a surface defining an XY plane, the XY plane having an X axis and a Y axis;
an X guide coupled to the base;
a first set of three main bearings riding on the surface and configured to constrain a Y stage in a Z direction perpendicular to the XY plane and to rotationally constrain the Y stage in an α and β directions where a is rotation about the X axis and β is rotation about the Y axis, wherein the Y stage is coupled to the X guide and the X guide linearly constrains the motion of the Y stage along the Y axis and constrains the angular motion of the Y stage in the γ direction, where γ is rotation about the Z axis, the Y stage configure to travel along the X guide in the X direction;
a second set of three main bearings coupled to the XY plane and configured to linearly support a carriage in the Z direction and to rotationally constrain the carriage in the α and β directions, wherein the carriage is coupled to the Y stage and the Y stage linearly constrains the motion of the carriage along the X axis and constrains the angular motion of the carriage in the γ direction, the carriage configure to travel along the Y stage in the Y direction.

10. The XY planar system of claim 9, wherein the first set of main bearings and the second set of main bearings comprise vacuum preloaded air bearings and where the base is fabricated from a granite slab.

11. The XY planar system of claim 9, further comprising:
a first set of motors that act against the X reference guide and move the Y stage in the X direction;
a second set of motors that act against the Y stage and move the carriage in the Y direction.

12. The XY planar system of claim 11, wherein the first set of motors and the second set of motors comprise ceramic servo motors.

13. The XY planar system of claim 11, wherein the first set of motors and the second set of motors comprise linear servo motors.

14. The XY planar system of claim 9, further comprising:
a first measurement system configured to measure the relative motion of the Y stage with respect to the X reference guide;
a second measurement system configured to measure the relative motion of the carriage with respect to the Y stage.

15. The XY planar system of claim 9, wherein the carriage moves in the XY plane with a rotation in an α and β directions of less than one arc-second, where α is rotation about the X axis and β is rotation about the Y axis.

16. An XY planar system comprising:
a base having a surface defining an XY plane wherein the XY plane has an X axis and a Y axis;
a means for supporting a Y stage in a Z axis wherein the Z axis is perpendicular to the XY plane;
a means for translating the Y stage in an X axis on the XY plane;
a means for supporting a carriage in the Z axis;
a means for translating the carriage in a Y axis of the XY plane.
